(19) United States
(12) Patent Application Publication
(10) Pub. No.: US 2025/0274789 A1
(43) Pub. Date: Aug. 28, 2025

(54) Real time Digital Twin Representation of a Radio Area Network Through A Vector Database

(71) Applicant: DISH Wireless L.L.C., Englewood, CO (US)

(72) Inventors: Mostafa TOFIGHBAKHSH, Cupertino, CA (US); Arash MAHMOUDIAN, Lakewood, CO (US); Abbas KHAN, Aurora, CO (US); Mahdi KHANSARI, Littleton, CO (US)

(21) Appl. No.: 18/586,932

(22) Filed: Feb. 26, 2024

(51) Int. Cl. H04W 24/08; G06F 16/22

(52) U.S. Cl. CPC H04W 24/08; G06F 16/2237

(57) ABSTRACT

A system and method for managing a Radio Access Network (RAN) is disclosed. The method involves receiving performance indicators from network elements and organizing them as structured Key Performance Indicators (KPIs). The structured KPIs are then arranged in a vector database. By querying the vector database, the network behavior of the RAN can be depicted in near real-time. This method provides an efficient and effective approach to monitor and analyze the performance of a RAN, enabling network operators to make informed decisions and optimize network performance.

### FIELD

The present teachings provide creation of a real-time digital twin representation of a network behavior using matrices, and real time computation of Key Performance Indicators (KPIs) and their correlations. The network may be a RAN, for example, a 5G cloud-based network. The teachings facilitate automated network analysis and operational decision-making.

### BACKGROUND

In the era of digital transformation, mobile wireless networks have become an integral part of our daily lives. These networks are increasingly complex, generating vast amounts of data on a daily basis. This complexity and volume of data present significant challenges in terms of real-time characterization and management, particularly with the emergence of 5G cloud-native networks. often fall short, as they are unable to keep up with the real-time demands of the network. They approaches

The manual collection is prone to human error, results in inefficiencies and produces delays in decision-making, all of which can have significant impacts on network performance and reliability.

Moreover, the lack of real-time visibility into network behavior poses a significant challenge for network operators. Without a clear understanding of how the network is performing in real-time, it is difficult to identify and address issues promptly, which can lead to service disruptions and degraded user experience.

In addition, the increasing demand for high-speed, reliable mobile connectivity is putting additional pressure on network operators to improve their network management and analysis capabilities. As such, there is a growing need for innovative solutions that can address these challenges and enable more efficient and effective management of mobile wireless networks.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Today's cloud native mobile networks are very complex to characterize. Specifically the networks are generating terabytes of data daily where it is extremely difficult for humans to characterize in real time. Full automation is necessary to manage the emerging 5G cloud native networks. The present approach provides a real time representation of network behavior of digital twins with real time computation KPIs and their correlations. Workflow automation is available for an operation team to observe the RAN behaviors through real time queries and open APIs. The automation of network behavior analysis is enabled by organizing the KPIs into a vector DB and providing feature dimension computation from the counters, events and alarms reported by the RAN infrastructure. Representing radios with digital twins permits working in an environment, instead of trying them in the physical world, allows for visualizing various radio settings.

In some aspects, the techniques described herein relate to a computer-implemented method for characterizing a Radio Access Network (RAN) including network elements, the method including: receiving streams of performance indicators from network elements; computing Key Performance Indicators (KPIs) and associated correlations based on the performance indicators; organizing the KPIs and the associated correlations into a vector database; and depicting, in real-time, a network behavior of the RAN with a similarity search query of the vector database, wherein the performance indicators include counters, events and alarms.

In some aspects, the techniques described herein relate to a method, wherein the organizing includes indexing the KPIs and the associated correlations and the computing is performed prior to the organizing.

In some aspects, the techniques described herein relate to a method, further including disseminating the receiving, the computing and the organizing over a plurality of platforms in real-time.

In some aspects, the techniques described herein relate to a method, wherein the KPIs are structured KPIs or matrices.

In some aspects, the techniques described herein relate to a method, wherein the associated correlations include a running average.

In some aspects, the techniques described herein relate to a method, wherein the associated correlations are selected by a Subject Matter Expert (SME).

In some aspects, the techniques described herein relate to a method, wherein the computing further includes computing a feature dimension for the KPIs.

In some aspects, the techniques described herein relate to a method, wherein the similarity search query is performed per a selected network site model.

In some aspects, the techniques described herein relate to a method, wherein the depicting includes a workflow automation to monitor performance of the RAN.

In some aspects, the techniques described herein relate to a method, wherein the workflow automation performs a performance analysis through an Application Programming Interface (API).

In some aspects, the techniques described herein relate to a method, further including conducting a comparison check of an operational requirement against a running average associated with one or more of the KPIs of a RAN cell, wherein the RAN cell is represented with a digital replica in the vector database.

In some aspects, the techniques described herein relate to a method, wherein the depicting illustrates a running average and a similarity check for an operational requirement.

In some aspects, the techniques described herein relate to a method, further including performing cause analysis of a RAN cell by querying the vector database.

In some aspects, the techniques described herein relate to a method, further including associating a decoration including an operating environment description with some of the KPIs.

In some aspects, the techniques described herein relate to a method, further including post-processing the vector database to make an informed decision as to a RAN state relative to a RAN operator policy.

In some aspects, the techniques described herein relate to a method, wherein the vector database includes a representation of a network digital twin of a RAN cell.

In some aspects, the techniques described herein relate to a system to characterize a Radio Access Network (RAN) including network elements, the system including: a Southbound Application Processing Interface (API) to receive streams of performance indicators from network elements; a Radio Digital Twin (RDT) Observability Platform to compute Key Performance Indicators (KPIs) and associated correlations based on the performance indicators; a vector database to organize the KPIs and the associated correlations; and a Northbound API to depict, in real-time, a network behavior of the RAN with a similarity search query of the vector database, wherein the performance indicators include counters, events and alarms.

In some aspects, the techniques described herein relate to a system, wherein the KPIs are structured KPIs or matrices.

In some aspects, the techniques described herein relate to a system, wherein the Northbound API includes a workflow automation to monitor performance of the RAN.

In some aspects, the techniques described herein relate to a system, wherein the Northbound API conducts a comparison check of an operational requirement against a running average associated with one or more of the KPIs of a RAN cell, wherein the RAN cell is represented with a digital replica in the vector database.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates an embodiment of a hybrid cloud cellular network.

FIG. 2 illustrates an embodiment of a 5G Core.

FIG. 3 illustrates an embodiment of a hybrid cloud cellular network architecture.

FIG. 4 illustrates a system to handle streams of performance data reported by a RAN infrastructure, according to various embodiments.

FIG. 5 illustrates a system providing Radio Digital Twin (RDT) observability using Automations and findings through Temporal Patterns, according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

### INTRODUCTION

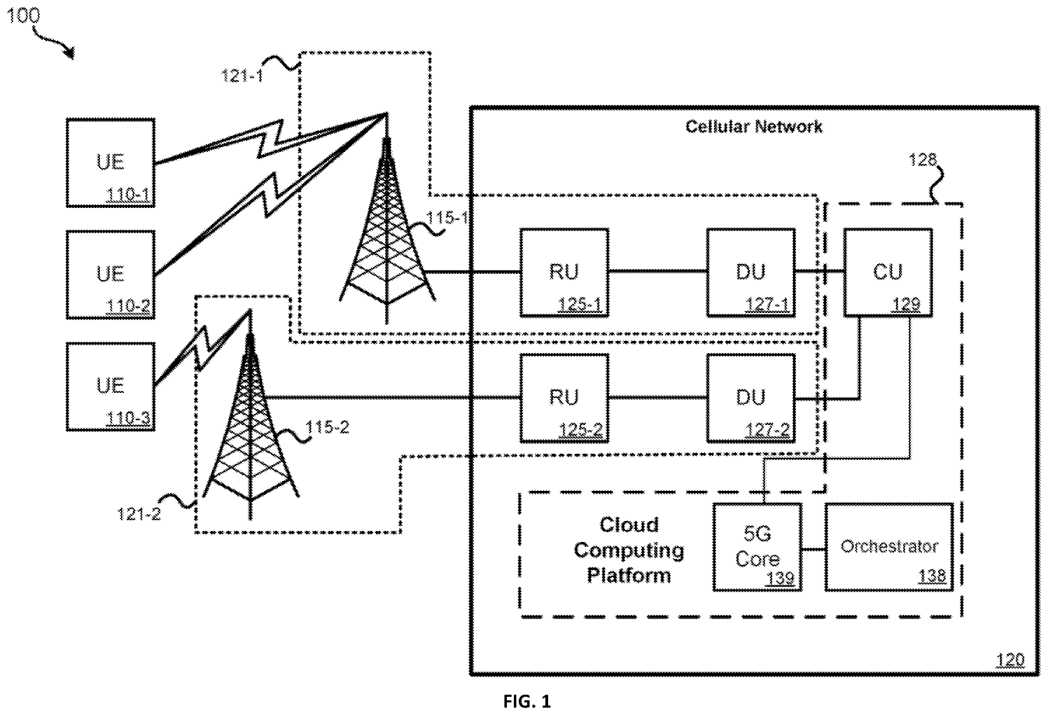

FIG. 1 illustrates a block diagram of a hybrid cellular network system (“system 100”). System 100 can include a 5G New Radio (NR) cellular network; other types of cellular networks, such as 6G, 7G, etc., may also be possible. System 100 can include: UE 110 (UE 110-1, UE 110-2, UE 110-3); structure 115; cellular network 120; radio units 125 (“RUs 125”); distributed units 127 (“DUs 127”); centralized unit 129 (“CU 129”); 5G core 139; and orchestrator 138. FIG. 1 represents a component-level view. In an open radio access network (O-RAN), most components, except for components that need to receive and transmit RF, can be implemented as specialized software executed on general-purpose hardware or servers. For at least some components, the hardware may be maintained by a separate cloud-service computing platform provider. Therefore, the cellular network operator may operate some hardware (such as, RUs and local computing resources on which DUs are executed) connected with a cloud-computing platform on which other cellular network functions, such as the core and CUs are executed.

UE 110 can represent various types of end-user devices, such as cellular phones, smartphones, cellular modems, cellular-enabled computerized devices, sensor devices, robotic equipment, IoT devices, gaming devices, access points (APs), or any computerized device capable of communicating via a cellular network. More generally, UE 110 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, or the like. Depending on the location of individual UEs, UE 110 may use RF to communicate with various BSs of cellular network 120. BS 121 may include an RU (e.g., RU 125-1) and a DU (e.g., DU 127-1). Two BSs 121 (BS 121-1 and BS 121-2) are illustrated. BS 121-1 can include: structure 115-1, RU 125-1, and DU 127-1. Structure 115-1 may be any structure to which one or more antennas (not illustrated) of the BS are mounted. Structure 115-1 may be a dedicated cellular tower, a building, a water tower, or any other man-made or natural structure to which one or more antennas can reasonably be mounted to provide cellular coverage to a geographic area. Similarly, BS 121-2 can include: structure 115-2, RU 125-2, and DU 127-2.

Real-world implementations of system 100 can include many (e.g., thousands) of BSs and many CUs and 5G core 139. BS 121-1 can include one or more antennas that allow RUs 125 to communicate wirelessly with UEs 110. RUs 125 can represent an edge of cellular network 120 where data is transitioned to RF for wireless communication. The radio access technology (RAT) used by RU 125 may be 5G NR, or some other RAT. The remainder of cellular network 120 may be based on an exclusive 5G architecture, a hybrid 4G/5G architecture, or some other cellular network architecture that supports cellular network slices.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. In some embodiments, an RU can also operate on three bands. One or more DUs, such as DU 127-1, may communicate with CU 129. Collectively, an RU, DU, and CU create a gNodeB, which serves as the radio access network (RAN) of cellular network 120. DUs 127 and CU 129 can communicate with 5G core 139. The specific architecture of cellular network 120 can vary by embodiment. Edge cloud server systems (not illustrated) outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized implementation, CU 129, 5G core 139, and/or orchestrator 138 can be implemented virtually as software being executed by general-purpose computing equipment on a cloud-computing platform 128, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where 5G core 139 is executed, while other functions are executed at a separate server system or on a separate cloud computing system. In the illustrated embodiment of system 100, cloud-computing platform 128 can execute CU 129, 5G core 139, and orchestrator 138. The cloud-computing platform 128 can be a third-party cloud-based computing platform or a cloud-based computing platform operated by the same entity that operates the RAN. Cloud-based computing platform 128 may have the ability to devote additional hardware resources to cloud-based cellular network components or implement additional instances of such components when requested.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU for test, orchestrator 138 can perform a pipeline of calling the DU code from a software repository incorporated as part of, or separate from cellular network 120, pulling corresponding configuration files (e.g. helm charts), creating Kubernetes nodes/pods, loading DU containers, configuring the DU, and activating other support functions (e.g. Prometheus, instances/connections to test tools). While this instantiation of a DU may be triggered by orchestrator 138, a chaos test system may introduce false DU container images in the repo, may introduce latency or memory issues in Kubernetes, may vary traffic messaging, and/or create other “chaos” in order to conduct the test. That is, chaos test system is not only connected to a DU, but is connected to all the layers and systems above and below a DU, as an example.

Kubernetes, Docker®, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The traditional OSS/BSS stack exists above orchestrator 138. Chaos testing of these components, as well as other higher layer custom-built components. Such components can be required sources of information and agents for testing at the service/app/solution layer. One aim of chaos testing is to verify the business intent (service level objectives (SLOs) and SLAs) of the solution. Therefore, if we commit to a SLA with certain key performance indicators (KPIs), chaos testing can allow measuring of whether those KPIs are being met and assess resiliency of the system across all layers to meeting them.

A cellular network slice functions as a virtual network operating on an underlying physical cellular network. Operating on cellular network 120 is some number of cellular network slices, such as hundreds or thousands of network slices. Communication bandwidth and computing resources of the underlying physical network can be reserved for individual network slices, thus allowing the individual network slices to reliably meet defined SLA requirements. By controlling the location and amount of computing and communication resources allocated to a network slice, the QoS and QoE for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus optimization between performance and cost is desirable.

Particular parameters that can be set for a cellular network slice can include: uplink bandwidth per UE; downlink bandwidth per UE; aggregate uplink bandwidth for a client; aggregate downlink bandwidth for the client; maximum latency; access to particular services; and maximum permissible jitter.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include multiple defined slice layers. Each layer within a network slice may be used to define parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

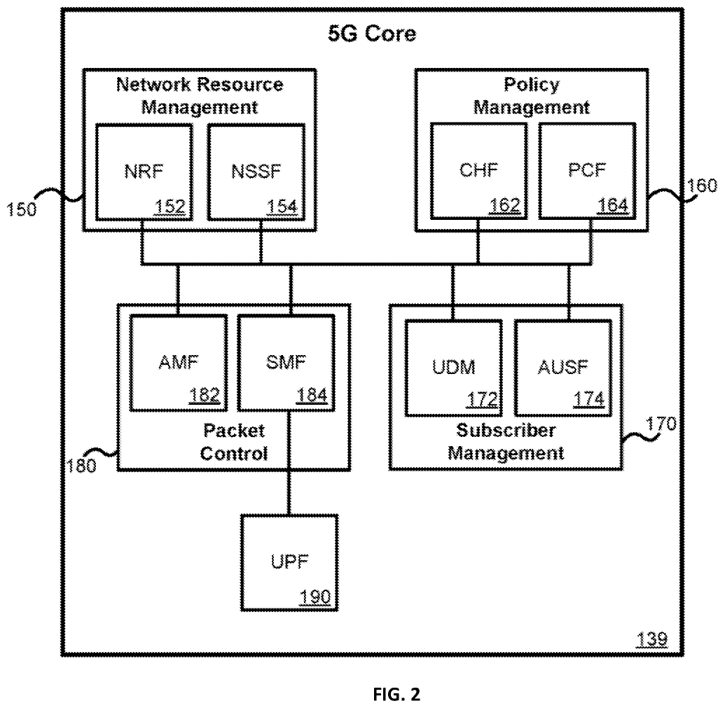

FIG. 2 illustrates a block diagram of a cellular network core, which can represent 5G core 139. 5G core 139 can be implemented on a cloud-computing platform. 5G core 139 can be physically distributed across data centers, or located at a central national data center (NDC), and can perform various core functions of the cellular network. 5G core 139 can include: network resource management components 150; policy management components 160; subscriber management components 170; and packet control components 180. Individual components may communicate on a bus, thus allowing various components of 5G core 139 to communicate with each other directly. 5G core 139 is simplified to show some key components. Implementations can involve additional other components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UE.

Packet control components 180 can include: Access and Mobility Management Function (AMF) 182 and Session Management Function (SMF) 184. AMF 182 can receive connection- and session-related information from UE and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, QoS handling, and external PDU sessions for interconnecting with a Data Network (DN) 195 (e.g., the Internet) or various access networks 197. Access networks 197 can include the RAN of cellular network 120 of FIG. 1A.

The functions illustrated in FIG. 2 as part of 5G core 139 are merely exemplary. Many more or different functions may be implemented in the cellular network core and may vary by slice. The amount of computing resources devoted to a particular function can vary by slice.

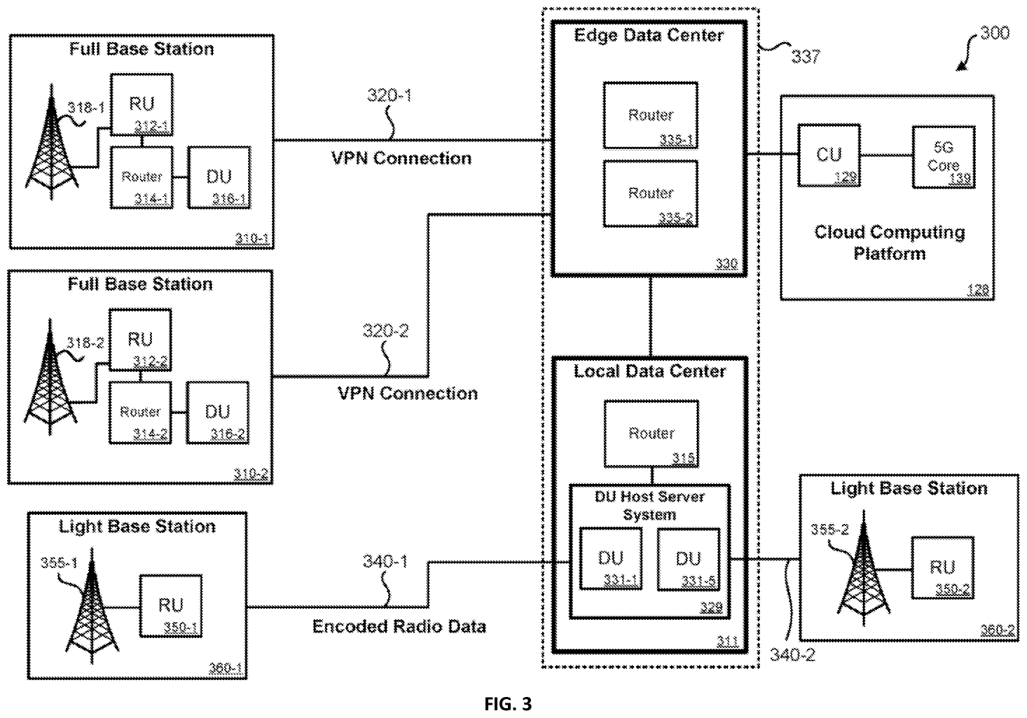

FIG. 3 illustrates an embodiment of hybrid cellular network system 300 (“system 300”) that includes hybrid use of local and remote DUs in communication with a cloud computing platform that hosts the cellular network core. System 300 can include: LDC 311; light BSs 360; full BSs 310; VLAN connections 320; edge data center 330 (“EDC 230”); CU 129; and 5G core 139, which are executed on cloud computing platform 128. In system 300, some base stations, referred to as “full base stations,” have DUs implemented locally at each BS. In contrast, a “light base station” includes structure (e.g., structures 355) and a local radio unit (e.g., RUs 350), but a DU implemented remotely at a geographically separated LDC. In system 300, either light BSs 360 or full BSs 310 may be referred to as a cell site.

LDC 311 can serve to host DU host server system 329, which can host multiple DUs 331 which are remote from corresponding light base stations 360. For example, DU 331-1 can perform the DU functionality for light base station 360-1. DUs with DU host server system 329 can communicate with each other as needed.

LDC 311 can be connected with EDC 330. In some embodiments, LDC 370 and EDC 330 may be co-located in a same data center or are relatively near each other, such as within 250 meters. EDC 330 can include multiple routers, such as routers 335, and can serve as a hub for multiple full BSs 310 and one or more LDCs 311. EDC 330 may be so named because it primarily handles the routing of data and does not host any RAN or cellular core functions. In a cloud-computing cellular network implementation at least some components, such as CU 129 and functions of 5G core 139, may be hosted on cloud computing platform 128. EDC 330 may serve as the past point over which the cellular network operator maintains physical control; higher-level functions of CU 129 and 5G core 139 can be executed in the cloud. In other embodiments, CU 129 and 5G core 139 may be hosted using hardware maintained by the cellular network provider, which may be in the same or a different data center from EDC 330.

Full BSs 310, which include on-site DUs 316, may connect with the cellular network through EDC 330. A full BS, such as full BS 310-1, can include: RU 312-1; router 314-1; DU 316-1; and structure 318-1. Router 314-1 may have a connection to a high bandwidth communication link with EDC 330. Router 314-1 may route data between DU 316-1 and EDC 330 and between DU 316-1 and RU 312-1. In some embodiments, RU 312-1 and one or more antennas are mounted to structure 318-1, while router 314-1 and DU 316-1 are housed at a base of structure 318-1. Full BS 310-2 functions similarly to full BS 310-1. While two full BSs 310 and two light BSs 360 are illustrated in FIG. 3, it should be understood that these numbers of BSs are merely for exemplary purposes; in other embodiments, the number of each type of BS may be greater or fewer.

While encoded radio data is transmitted via the fiber optic connections 340 between light BSs 360 and LDC 370, connection 320-1 between full BSs 310 and EDC 330 may occur over a fiber network. For example, while the connection between light BS 360-1 and LDC 370 can be understood as a dedicated point-to-point communication link on which addressing is not necessary, full BS 310-1 may operate on a fiber network on which addressing is required. Multiprotocol label switching (MPLS) segment routing (SR) may be used to perform routing over a network (e.g., fiber optic network) between full BS 310-1 and EDC 330. Such segment routing can allow for network nodes to steer packetized data based on a list of instructions carried in the packet header. This arrangement allows for the source from where the packet originated to define a route through one or more nodes that will be taken to cause the packet to arrive at its destination. Use of SR can help ensure network performance guarantees and can allow for network resources to be efficiently used. Other full BSs may use the same types of communication link as full BS 310-1. While MPLS SR can be used for the network connection between full BSs 310 and EDC 330, it should be understood that other protocols and non-fiber-based networks can be used for connections 320.

For communications across connection 320-1, a virtual local area network (VLAN) may be established between DU 316-1 and EDC 330, when a fiber network that may also be used by other entities is used. The encryption of this VLAN helps ensure the security of the data transmitted over the fiber network.

Since light BSs 360 are relatively close to LDC 370, typically in a dense urban environment, use of a dedicated point-to-point fiber connection can be relatively straight-forward to install or obtain (e.g., from a network provider that has available dark fiber or fiber on which bandwidth can be reserved). However, in a less dense environment, where full BSs 310 can be used, a point-to-point fiber connection may be cost-prohibitive or otherwise unavailable. As such, the fiber network on which MPLS SR is performed and the VLAN connection is established can be used instead. Further, the total amount of upstream and/or downstream data from a light BS to an LDC may be significantly greater than the amount of upstream and/or downstream data from a DU of a full BS to EDC 337, thus requiring a dedicated fiber optic connection to satisfy the bandwidth requirements of light BSs.

To perform chaos testing, a small portion of the cellular network can be simulated and tested, followed by larger portions of the cellular network as needed to verify functionality and robustness. Once satisfied as to performance in a test environment, testing can be performed in a restricted production environment, followed by release into the general production environment. On each of these levels, some amount of chaos testing can be performed.

### Improvements

The present teachings provide a real time representation of network behavior using digital twins of network elements. A workflow automation is provided to observe Radio Area Network (RAN) behaviors. The observations may be made through real time queries and open APIs. The teachings enable automation of network behavior analysis by organizing the KPIs into a vector DB.

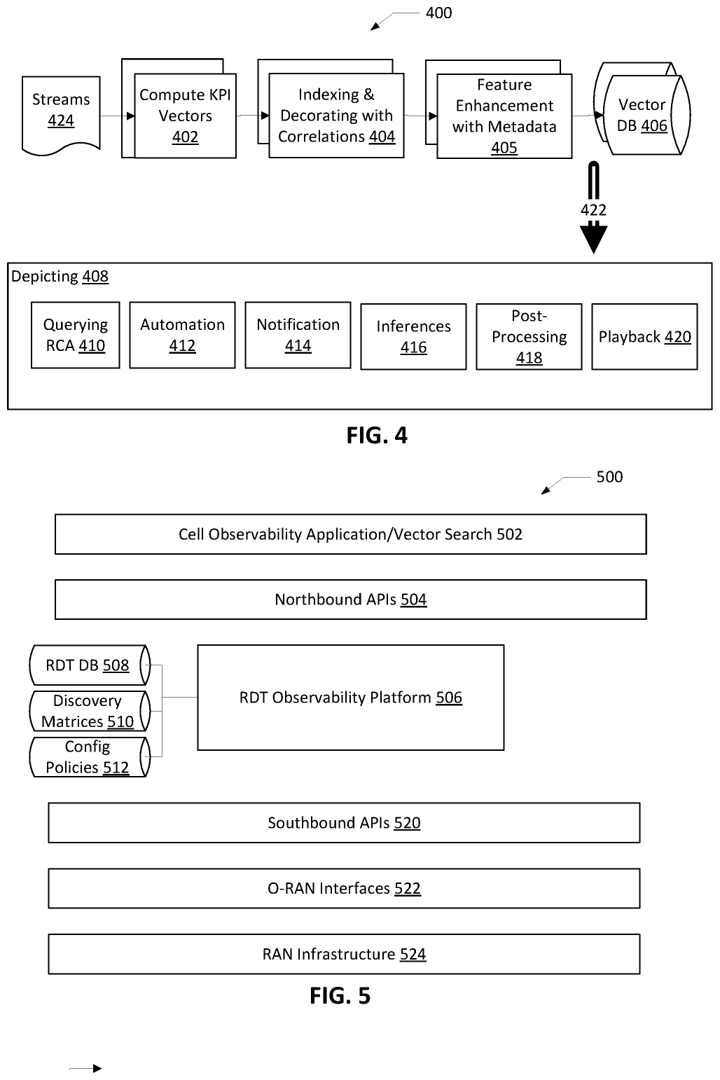

FIG. 4 illustrates a system to handle streams of performance data reported by a RAN infrastructure, according to various embodiments.

FIG. 4 illustrates a system 400 to handle streams 424 of performance data reported by the RAN infrastructure to compute wireless KPI vector embeddings 402 organized (for example, by indexing and decorating with correlations 404 and feature enhancement with metadata 405) in a vector database (DB) 406. Depicting 408 may utilize with a RAN twin representation in the vector DB 406. Exemplary depicting 408 may include querying RCA 410, automation 412, notification 414, inference engine 416, post-processing applications 418 and playback. Depiction 408 may be customized by a Subject Matter Expert (SMEs). The customization may be by a device type of the RAN infrastructure device reporting. The customization may be by geolocation of a RAN infrastructure device.

The vector DB 406 organization provides feature dimension computation from streams 424 of counters and events and alarms reported by the RAN infrastructure. Vector database 408 may provide similarity searching. In some embodiments, fast and accurate similarity searching and retrieval of data may be performed by the vector DB 406. Some of the most common use cases for vector DB 406 include comparing KPIs with historical data or deviation from other averages or expected results.

Computational elements 402 may receive streams of counters, events, alarms and performance data from network elements of the RAN. The computational elements 402 may perform KPI depiction, feature decorating and indexing of KPIs, for example, in real-time. The computational elements 402 maybe used prior to storing output of the computational elements such as KPIs, correlations, structured KPIs and the like in vector DB 406. The vector DB 406 maybe distributed.

Real-time or real time describes various operations in computing or other processes that must guarantee response times within a specified time (deadline), usually a relatively short time, or sufficiently rapidly for interactive uses, such as for rapid control or communication systems. A real-time process is generally one that happens in defined time steps of maximum duration or fast enough to affect the environment in which it occurs, such as inputs to a RAN.

The KPIs and features stored in the vector DB 406 maybe queried for depicting 408, for example, by post-processing applications 418 on behalf of an enterprise, for example, a Subject Matter Expert (SME). The queries allow a RAN SME to determine average and similarity checks for various operational needs. The state of RANs relative to an operator's policies may be determined by using post processing applications querying the vector DB. The post processing applications 408 handling the KPI vector embeddings allow the SME to make an informed decision based on real-time behaviors of their respective network elements. The behaviors are viewed by querying the digital twin representation of the RAN in the vector DB 406.

Various KPI vector indexes may be created as needed by the post-processing applications. The vector DB indexes enable fast querying for automation and root cause analytics. The structured KPIs in the vector DB form the representation of network digital twins.

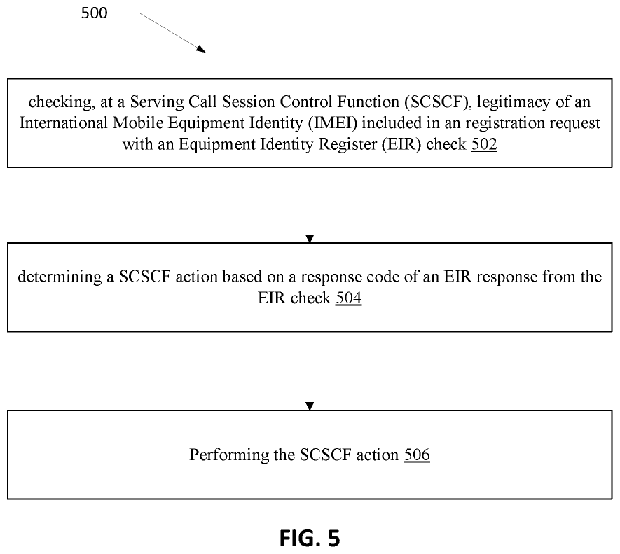

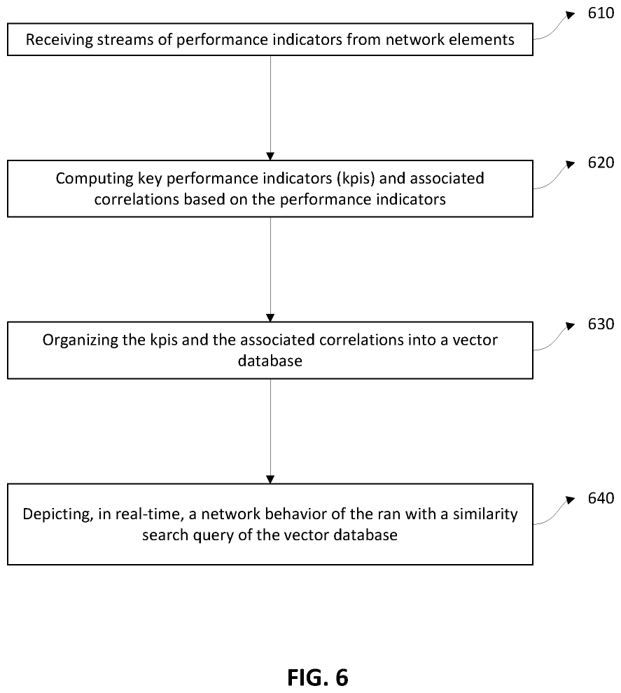

FIG. 5 illustrates a system providing Radio Digital Twin (RDT) observability using Automations and findings through Temporal Patterns, according to various embodiments.

A system 500 may provide Radio Digital Twin (RDT) observability using Automations and findings through Temporal Patterns (Trends, Seasonality, Cyclic Patterns, Autocorrelation). The system 500 may provide Radio Topology, Usage Analytics, Fault Isolation, Root Cause Analysis, Visualization, and Similarity tests. The system 500 may provide RDT core functionality for a RAN infrastructure 524 with an RDT observability platform 506. The RAN infrastructure 524 includes, but is not limited to, cell sites, radios, RU, DU, CU, rt-RIC, Non-NR-RIC, topologies, beams, slices, usage, intent and tunnels.

The RDT observability platform 506 may utilize a RDT DB 508, discovery matrices 510 and config policies 512. The RDT DB 508 may be a vector DB and track performance of the RAN infrastructure 524. The RDT DB 508 tracks and is useful to identify Real Time Events, Topology Updates, Real time observations, Discovery of cell site usage, Power, RF conditions, and other KPIs.

System 500 may include a northbound API 514 for depicting. Northbound API 514 may include APIs for Datastax, GRP, Streaming, Starlite or the like. Northbound API 514 may be used a cell observability application 502. Cell observability application 502 may include xApps, third party applications, LLM, and vector searching.

System 500 may include a southbound API 520 for receiving streams of performance data. Southbound API 520 may utilize various O-RAN interfaces 522 of RAN infrastructure 524 devices. Southbound API 520 may be vendor provided. Southbound API 520 may be provided as plug-ins, for example, Kafa plug-ins.

The discovery matrices 510 may store network topology of the RAN infrastructure. The policies 512 may be used by the RDT observability platform 506 to provide a comparator for measuring performance. The RDT observability platform 506 may provide insights into Discoveries of RAN infrastructure, Live Spectrum Utilization, Beam Forming Behaviors, Slice Management and Failure Events.

Vector databases are used for a variety of tasks that require fast and accurate similarity search and retrieval of data based on their vector distance or similarity. Some of the most common use cases for vector databases includes comparing KPIs with historical data or deviation from other averages or expected results.

FIG. 6 is a flowchart of an example method 600 for characterizing a Radio Access Network (RAN).

At operation 610, method 600 includes receiving streams of performance indicators from network elements. At operation 620, method 600 includes computing Key Performance Indicators (KPIs) and associated correlations based on the performance indicators. At step 630, method 600 includes organizing the KPIs and the associated correlations into a vector database. At step 640, method 600 includes depicting, in real-time, a network behavior of the RAN with a similarity search query of the vector database.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A computer-implemented method for characterizing a Radio Access Network (RAN) comprising network elements, the method comprising:
receiving streams of performance indicators from network elements;
computing Key Performance Indicators (KPIs) and associated correlations based on the performance indicators;
organizing the KPIs and the associated correlations into a vector database; and
depicting, in real-time, a network behavior of the RAN with a similarity search query of the vector database,
wherein the performance indicators comprise counters, events and alarms.

2. The method of claim 1, wherein the organizing comprises indexing the KPIs and the associated correlations and the computing is performed prior to the organizing.

3. The method of claim 1, further comprising disseminating the receiving, the computing and the organizing over a plurality of platforms in real-time.

4. The method of claim 1, wherein the KPIs are structured KPIs or matrices.

5. The method of claim 1, wherein the associated correlations comprise a running average.

6. The method of claim 1, wherein the associated correlations are selected by a Subject Matter Expert (SME).

7. The method of claim 1, wherein the computing further comprises computing a feature dimension for the KPIs.

8. The method of claim 1, wherein the similarity search query is performed per a selected network site model.

9. The method of claim 1, wherein the depicting comprises a workflow automation to monitor performance of the RAN.

10. The method of claim 9, wherein the workflow automation performs a performance analysis through an Application Programming Interface (API).

11. The method of claim 1, further comprising conducting a comparison check of an operational requirement against a running average associated with one or more of the KPIs of a RAN cell, wherein the RAN cell is represented with a digital replica in the vector database.

12. The method of claim 1, wherein the depicting illustrates a running average and a similarity check for an operational requirement.

13. The method of claim 1, further comprising performing cause analysis of a RAN cell by querying the vector database.

14. The method of claim 1, further comprising associating a decoration comprising an operating environment description with some of the KPIs.

15. The method of claim 1, further comprising post-processing the vector database to make an informed decision as to a RAN state relative to a RAN operator policy.

16. The method of claim 1, wherein the vector database comprises a representation of a network digital twin of a RAN cell.

17. A system to characterize a Radio Access Network (RAN) comprising network elements, the system comprising:
a Southbound Application Processing Interface (API) to receive streams of performance indicators from network elements;
a Radio Digital Twin (RDT) Observability Platform to compute Key Performance Indicators (KPIs) and associated correlations based on the performance indicators;
a vector database to organize the KPIs and the associated correlations; and
a Northbound API to depict, in real-time, a network behavior of the RAN with a similarity search query of the vector database,
wherein the performance indicators comprise counters, events and alarms.

18. The system of claim 17, wherein the KPIs are structured KPIs or matrices.

19. The system of claim 17, wherein the Northbound API comprises a workflow automation to monitor performance of the RAN.

20. The system of claim 17, wherein the Northbound API conducts a comparison check of an operational requirement against a running average associated with one or more of the KPIs of a RAN cell, wherein the RAN cell is represented with a digital replica in the vector database.
